(19) United States
(12) Patent Application Publication
(10) Pub. No.: US 2011/0036339 A1
(43) Pub. Date: Feb. 17, 2011

(54) APPARATUS AND METHOD FOR MULTIPLE SUBSTRATE PROCESSING

(76) Inventors: Jong Jae Jung, Singapore (SG); Deok Chun Jang, Singapore (SG); Chang Hwan Ha, Singapore (SG); Chong Chen Lim, Singapore (SG); Seung Ho Baek, Singapore (SG)

Correspondence Address: KNOBBE MARTENS OLSON & BEAR LLP, 2040 MAIN STREET, FOURTEENTH FLOOR, IRVINE, CA, 92614, US

(21) Appl. No.: 12/990,491

(22) PCT Filed: May 4, 2009
(86) PCT No.: PCT/SG09/00158

§ 371 Date: Oct. 29, 2010

(30) Foreign Application Priority Data
May 2, 2008 (SG) 200803452-2

(51) Int. Cl. B28D 5/00

(52) U.S. Cl. 125/30.01

(57) ABSTRACT

A system for cutting a plurality of substrates of integrated circuit units comprising a plurality of tables (40, 55), each table including a plurality of trays (37A, 37B, 57A, 57B), each tray arranged to receive one of said substrates; each of said tables selectively movable between a respective loading station (20) for receiving said substrates and a cutting station for cutting the substrates, and a substrate placement device (35) for placing the substrates on the respective trays of said tables; wherein the substrate placement device is arranged to sequentially place substrates on said tables with said tables arranged to sequentially move to the cutting station after receiving the substrates and then return to their respective loading stations for placement of additional substrates.

### FIELD OF THE INVENTION

The invention relates to the processing of integrated circuit units and in particular the processes involved in cutting the units from substrates of a plurality of said units. Further the invention relates to methods for optimizing the rate of processing of said units.

### BACKGROUND OF THE INVENTION

Integrated circuit units are generally rectilinear, i.e. having straight sides at right angles to each other. The most efficient form of dicing or cutting these units from a substrate is generally using a dicing saw which performs a straight cut very quickly in comparison to other such cutting methods.

The evolution of the consumer electronics industry, however, has led to various shapes of integrated circuit units to fit within said devices particularly for SD and SD microchips used for replaceable memory storage. Such chips are often not rectilinear but instead, may have only portions which are both straight and at right angles. The remaining peripheral edge may be curvilinear which will include curved edges as well as straight edges which are not at right angles or instead, may include edges which are of an incremental length and, therefore, demonstrate a step arrangement which may be too fine or profiled for the efficient use of a dicing saw. In such a case, other cutting methods may be adopted which are more suitable for cutting such profiled edges but may not be as fast as a dicing saw. An example includes the use of high pressure water jets or alternatively, lasers in order to effect these cuts. An example of a system whereby a dicing saw and a profile cutting means are combined to produce a more efficient system for cutting is disclosed in PCT publication no. WO2007/073356, the contents of which are incorporated herein by reference.

The aforementioned system is arranged to maximize the speed of processing of the integrated circuit units through the cutting zones as profile cutting devices, whilst useful for profile cutting, are inherently slower than a dicing saw. It is the speed of the profile cutting devices that limits their use and it would, therefore, be useful to have a system whereby the rate of processing using a profile cutting device is increased.

### SUMMARY OF INVENTION

In a first aspect the invention provides A system for cutting a plurality of substrates of integrated circuit units comprising a plurality of tables, each table including a plurality of trays, each tray arranged to receive one of said substrates; each of said tables selectively movable between a respective loading station for receiving said substrates and a cutting station for cutting the substrates, and; a substrate placement device for placing the substrates on the respective trays of said tables; wherein the substrate placement device is arranged to sequentially place substrates on said tables with said tables arranged to sequentially move to the cutting station after receiving the substrates and then return to their respective loading stations for placement of additional substrates.

In a second aspect, the invention provides A method for cutting a plurality of substrates of integrated circuit units comprising the steps of: Providing at least two selectively movable tables; loading a portion of said plurality of substrates to a first of said tables, each table including a plurality of trays, each tray arranged to receive one of said substrates; moving said first table to a cutting station; cutting said substrates; loading a second of said tables with a further portion of said plurality of substrates; moving said cut substrate from said first table; moving the first table to the first loading station; moving the second table to the cutting station; cutting the substrate on the second table; removing the cut substrate from the second table; moving the second table to the second loading station.

This system is particularly useful where a profiled cutting device is preferred for all the cutting of an integrated circuit unit. In such a case, the increased speed of combining with a dicing saw cannot be benefited. Accordingly the increase of multiple substrates subject to the cutting, not just within the cutting zone but also within the pre-processing of the substrates, therefore, increases the rate of units per hour (UPH) and so improving the rate of processing by a profile cutting device.

It will be noted that at the cutting station, the substrates may be completely cut through. Alternatively, the cutting device, in this case a laser head, may cut through the integrated circuit units but not completely through the substrates. The integrated circuits may be located upon a mould such that whilst the integrated circuit units can be completely cut through, the laser head only partially cuts through the underlying mould. Thus the integrated circuit units may remain in contact with the substrate and so remain as a single strip even though the units themselves have been singulated.

It will be noted that the laser head is capable of cutting a variety of materials including metal, ceramic, plastic, glass and other such materials available for use as integrated circuits or moulds for substrates.

As mentioned previously the device 5 may be adapted for use with a conventional dicing saw device. In this way, the laser head may be adapted to only perform profile cutting of the substrates and, therefore, the integrated circuit units may not be singulated but only having profile cuts taken, and depth control cutting. Such substrates may then be delivered to a dicing saw device for completion of the dicing process. This differentiates from the disclosure in WO2007/073356 whereby the profile cutting and dicing saw arrangement combine to form a single process.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIG. 1 is a plan view of a processing device according to one embodiment of the present invention;

FIG. 2 is a flow chart of a process according to a further embodiment of the present invention;

FIGS. 3A to 3C are elevation views of substrates having cuts of varying depth.

### DETAILED DESCRIPTION OF DRAWING

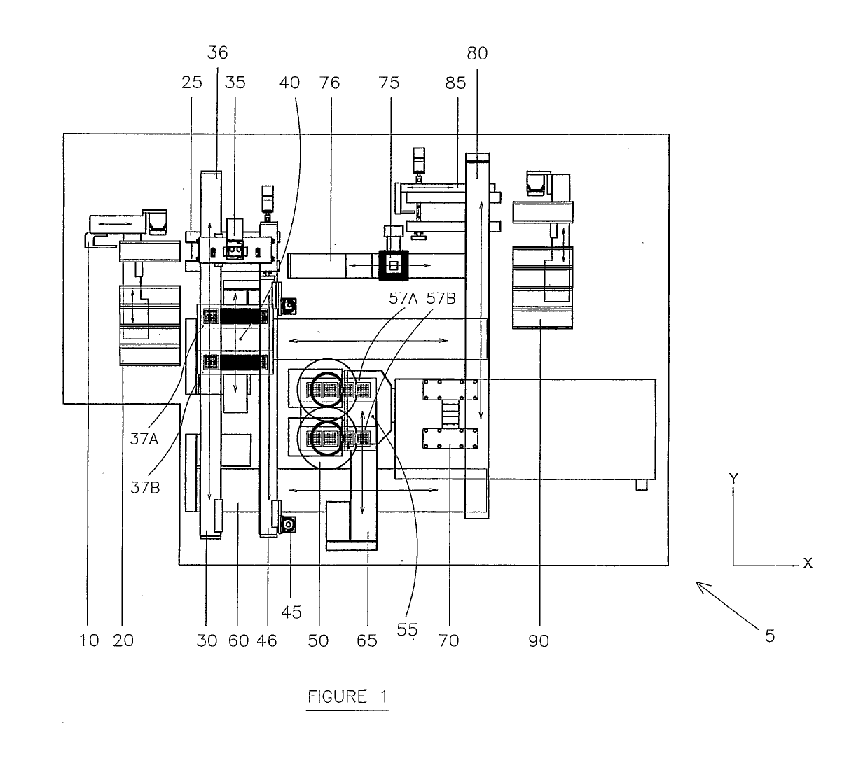

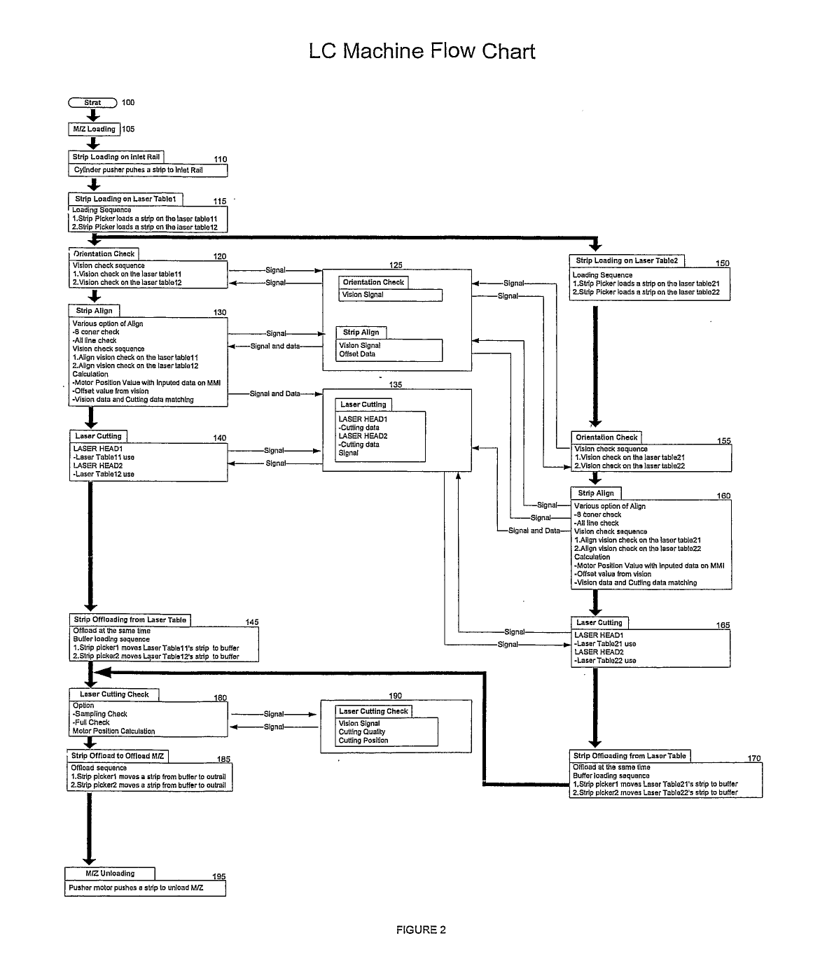

FIGS. 1 and 2 show complementary embodiments of the present invention whereby multiple substrates are delivered to multiple tables for alignment and cutting processes so as to increase the UPH of units through the device.

In particular FIG. 1 shows such a device according to an embodiment of the present invention. The device 5 includes a loading mechanism whereby an onloader 20 collates and racks substrates ready for delivery to the device. The substrates are sequentially moved down the onloader 20 until they reach the onset point where upon a pusher 10 pushes them into engagement with an inlet rail 25. The device 5 includes a substrate placement device which in this embodiment includes a frame lifter 35 mounted to a linear rail 36. The frame lifter 35 engages the substrate within the inlet rail 25 through a vacuum source and lifts the substrate to one of two trays 37A, B located on a first table 40. Further located in this region is an alignment inspection device which includes an imaging device, such as a camera, 45 mounted to a second linear rail 46. The imaging device 45 can move freely along the rail and so check the substrates for their alignment within the trays and the table.

Following inspection by the alignment vision device 45, the table is movable to a cutting zone whereby substrates mounted to the table are cut using a dual laser head 50.

The now singlulated units are removed from the table by an off loader picker 70 for eventual off loading. The table 55, now empty of units, moves back to the linear rail 30.

The key aspect of the invention is the ability of the system to have in this embodiment, two tables 40, 55 operating simultaneously. That is, whilst the first table is undergoing cutting, the second table is being loaded with substrates and undergo alignment inspection. When the table undergoing cutting is finished, it moves back to the linear rail so that it can be further loaded with substrates and the next table moves to the cutting zone. Thus, a sequence of:
(i) load first table;
(ii) inspect first table;
(iii) cut first table;
(iv) load second table;
(v) inspect second table;
(vi) remove units from first table;
(vii) move empty first table to loading station;
(viii) out second table;
(ix) load first table;
(x) inspect first table;
(xi) remove units from second table;
(xii) move empty second table to loading station.

Subsequent to the cutting cycle, the units are removed by unit removal device, such as a picker 70 and subsequently moved to a further inspection 75 whereby the units are inspected for defects. As the picker 70 grips/vacuum the units/substrate from above, inspection occurs at the outlet vision inspection zone 75 from underneath. The imaging device 75 moves along a linear rail and this together with movement of the picker 70 along its dedicated rail 80, permits full inspection of all the units held within the picker.

The inspected units are then delivered to an off loader whereby strips of units are pushed by pusher 85 to an off loading rack 90 for delivery to the customer.

FIG. 2 shows a more detailed process for an embodiment of the present invention. The process as detailed in FIG. 2 may be applied to a device such as that shown in FIG. 1 or to another device falling within the present invention.

The process begins 100 with loading of a magazine 105. The strip is loaded onto an inlet rail 110 which is pushed to the inlet rail. The strip is loaded to a first laser table 115 through first loading a strip to a first tray of the laser table using a strip picker and then the same strip picker loading a subsequent strip to the second tray within the first laser table. The strips undergo an orientation inspection 120 whereby an imaging device checks from above the strips lying in each of the first and second trays of the first laser table.

The orientation inspection station is in communication with a control system 125 whereby the signal received from the orientation check is recorded against the respective strip. In particular, the alignment information may be gained from a variety of inspection protocols including an eight corner check, whereby fiduciary marks for key points on the strip are identified, up to an “all line check” whereby each individual line of units is separately inspected. This has the advantage of ensuring alignment to be checked and recorded but suffering from a much longer inspection period. Accordingly the designer of the device will determine whether the greater assurance of alignment of the strip is balanced against the increase in inspection time. It will be noted that for an “all line check”, the period of inspection approximates that of the cutting of a substrate by the laser head.

Thus the calculation of the alignment 130 will use the alignment vision check for each of the trays from the first laser table and calculate:
(i) motor position value with inputted data on MMI;
(ii) offset value from vision;
(iii) vision data and cutting data matching.

This information and calculation is then sent to the control system 135 to be used by the laser heads during cutting. After the alignment check and calculation, the first table is sent to laser cutting 140 whereby said data is used in the cutting of the strips. The strip is then off loaded 145 whereby the strip picker removes units from each of the trays from the first table.

In parallel but staggered from the processing of the first laser table, when the strip picker is free from loading the first laser table, it will then load strip to the second laser table which has just had singulated units removed from it and returned to a loading position. The second laser table follows an identical path to that of the first laser table including an orientation check 155 calculation of the strip alignment 160 and subsequent laser cutting 165 and eventually having the singulated units removed from the second laser table 170.

Thus, the present invention seeks to optimize the UPH for the device by maximizing use of individual functional stations within the device including the strip picker alignment check and laser heads. By having two trays in a staggered parallel sequence, delay in usage of the functional stations is more a function of the varying processing times for each station. Thus, the strip picker becomes available for loading of strip once the table has been loaded and sent to the alignment check. Similarly the alignment check can be made available for a subsequent laser table when the present laser table is sent to cutting. It follows this is equally applicable for the laser cutting heads and the off loader picker.

In this embodiment, the tables are capable of carrying two substrates. The invention is not limited to merely two substrates per table but could have many substrates and equally each table may be adapted to receive several strips but process only those actually present. For instance a laser table may be capable of holding say four strips with the alignment check being used to identify whether each tray within the table is actually being occupied. Thus, in a particular batch run if only two of four trays are being used, the alignment check can identify this and ensure that the laser heads off loader picker and subsequent stations are informed of the actual number of strips to process.

The process continues after engaging the off loader picker whereby the units are taken to a laser cutting check 180 which might be a sampling check, i.e. randomly or selectively choosing units to inspect or a full check of each unit. The motor position may then be calculated. This information can be sent to a laser cutting check control system 190 which will recall and transmit the vision signal cutting quality and cutting position. The units are then off loaded to an off loader magazine 185. In this embodiment the units are off loaded as a strip and then individual lines of units can be pushed to the off loader magazine 195.

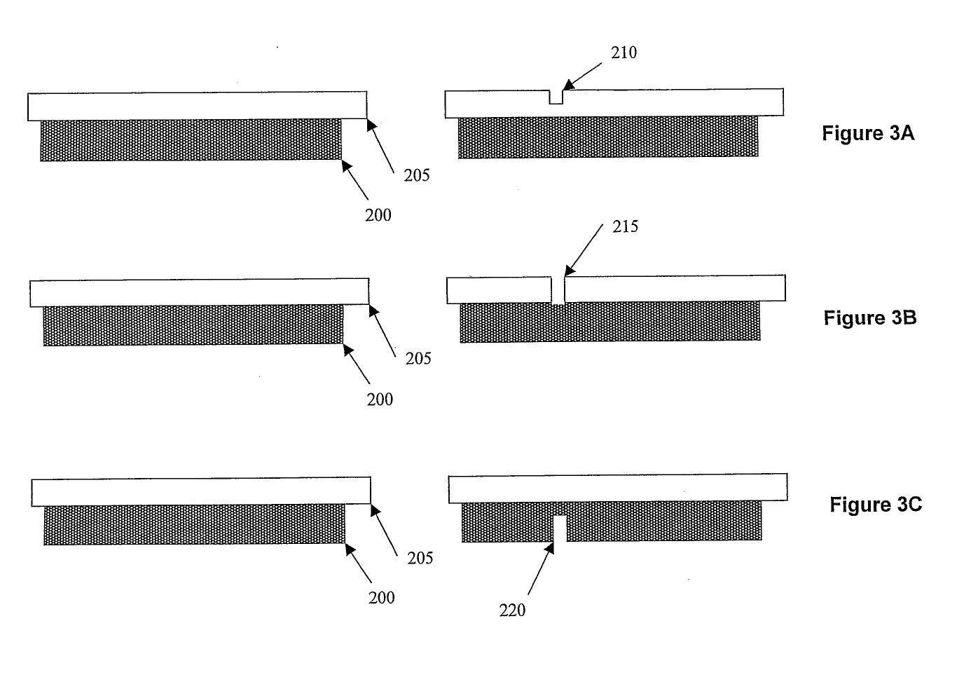

In one embodiment of the present invention, cutting at the cutting station may execute a full cut, and so singulating individual units from the substrate. FIGS. 3A to 3C show varying types of partial cuts that may also be possible according to specific embodiments of the present invention.

For full cutting using a partial/full cutting device such as a water jet or laser, but specifically excluding a dicing saw, the units, such as QFN, will involve a very slow process. For a QFN typical substrate having a copper strip 205 of thickness 0.2 mm, mounted on a plastic mold 200 of thickness 0.7 mm, only full cutting is practical. For a partial cutting device, the depth is subject to greater control.

The present invention permits cutting of the copper 205 only, as shown in FIG. 3A in order to increase sawing speed as following process. For example, if substrate has 0.9 mm thickness with 0.2 mm copper thickness, this system is able to control 0.2 mm cutting depth with certain cutting width by multiple cutting of the Beam. This can be extended to cutting the entire copper strip, and partially cut the mold. In this case, the units have been singulated, but are maintained as a strip due to the partial cut of the mold, as shown in FIG. 3B.

Another application involves flipping the substrate and cutting the mold from the opposite side, and so leaving the copper strip intact. Because of the greater thickness of the mold, and the tendency for plastic materials to retain considerable internal stresses ion cooling, there is a considerable differential stress in the mold. Further, this differential stress, because of the greater flexural strength of the mold as compared to the thin copper strip, can cause warping of the substrate. By executing a cut, such as that shown in FIG. 3C, the mold has reduced influence through cutting to a depth of up to 0.7 mm, with a preferred depth of 0.5 mm

1. A system for cutting a plurality of substrates of integrated circuit units, the system comprising:
a plurality of tables, each table including a plurality of trays, each tray arranged to receive one of said substrates;
each of said tables selectively movable between a respective loading station for receiving said substrates and a cutting station for cutting the substrates, and
a substrate placement device for placing the substrates on the respective trays of said tables,
wherein the substrate placement device is arranged to sequentially place substrates on said tables with said tables arranged to sequentially move to the cutting station after receiving the substrates and then return to their respective loading stations for placement of additional substrates.

2. The system according to claim 1, further comprising an alignment inspection station for inspecting substrates located on said tables, such that the alignment inspection station is located intermediate to the respective loading stations and the cutting station.

3. The system according to claim 1, wherein said respective loading stations are located along a common linear rail along which said tables selectively move.

4. The system according to claim 3, wherein said tables are selectively movable along-a respective orthogonal rails from said central linear rail to the cutting station.

5. The system according to claim 2, wherein said alignment inspection station includes an imaging device movable along a second linear rail such that the imaging device inspects said substrates when the tables are located at the respective loading stations.

6. The system according to claim 1, further comprising a unit removal device for removing the singulated integrated circuit units from said table when at the cutting station.

7. The system according to claim 6, further comprising a unit inspection station for inspecting said units when in contact with the unit removal device.

8. A method for cutting a plurality of substrates of integrated circuit units comprising the steps of:
providing at least two selectively movable tables;
loading a portion of said plurality of substrates to a first of said tables, each table including a plurality of trays, each tray arranged to receive one of said substrates;
moving said first table to a cutting station;
cutting said substrates;
loading a second of said tables with a further portion of said plurality of substrates;
moving said cut substrate from said first table;
moving the first table to the first loading station;
moving the second table to the cutting station;
cutting the substrate on the second table;
removing the cut substrate from the second table; and
moving the second table to the second loading station.

9. The method according to claim 8, further comprising the step of repeating the steps for subsequent tables.

10. The method according to claim 8, further comprising the step of removing the cut substrates from each table after each respective cutting step using a unit removal device.

11. The method according to claim 8, further comprising the step of inspecting each substrate when placed on a respective table prior to the respective cutting step.
